(19) United States
(12) Patent Application Publication
(10) Pub. No.: US 2016/0350857 A1
(43) Pub. Date: Dec. 1, 2016

(54) SYSTEM FOR NETWORK PAIRING OF INVESTORS AND ADVISORS BASED ON INVESTOR INFORMATION ANALYTICS

(71) Applicant: Bank of America Corporation, Charlotte, NC (US)

(72) Inventors: Katherine Dintenfass, Charlotte, NC (US); David M. Grigg, Rock Hill, SC (US); Alicia C. Jones-McFadden, Fort Mill, SC (US); Jeanne Ferullo Connolly, Braintree, MA (US); Craig Terrill, Barrington Hills, IL (US); Sahil Bahri, Chicago, IL (US); Sonny Tai, Chicago, IL (US); Markondapatnaikuni Samba Siva Patnaik, Chicago, IL (US)

(21) Appl. No.: 14/722,722

(22) Filed: May 27, 2015

(51) Int. Cl. G06Q 40/06

(52) U.S. Cl. CPC G06Q 40/06

(57) ABSTRACT

Embodiments of the invention are directed to systems, computer program products, and methods for creating investor network groups, in which like investors are grouped together in order to discuss, receive, and send investment information between like investors and one or more financial advisors in order to receive specialized advice without having to pay the high costs of a personal financial advisor. Since the investors within the one or more investor network groups are similarly situated investors with similar investor information (e.g., any information related to the investor profile information, investment strategy information, transaction history information, lifestyle information related to current lifestyles and future desired lifestyle in retirement, investing activity information, or like) inquiries made by investors within the group or suggested investment actions made by financial advisors for investors within the group may apply to multiple investors within the investor network group.

### FIELD

In general, embodiments of the invention relate to pairing like investors together in a network to provide investment support for a network of similar investors over the distributed network of investor systems.

### BACKGROUND

Investors off all different types desire to have different levels of service for different levels of need. Investors may not wish to have a financial advisor, wish to have general access to a financial advisor, desire to have regular contact with a financial advisor, or the like. Moreover, the assets an investor has may dictate the level of service that an investor may be provided or actually needs. Present systems do not provide the services that investors' desire or need by efficiently utilizing financial advisors within an organization.

### BRIEF SUMMARY

Embodiments of the present invention address the above needs and/or achieve other advantages by providing apparatuses (e.g., a system, computer program product, and/or other device) and methods for a system to provide a grouped network of related investors with access to investor network systems that allows investors to interact with applications, each other, and/or one or more financial advisors in order to receive the desired level of financial service for the related investors.

Embodiments of the invention are directed to systems, computer program products, and methods for creating investor network groups, in which like investors are grouped together in order to discuss, receive, and send investment information between like investors and one or more financial advisors in order to receive specialized advice without having to pay the high costs of a personal financial advisor. Since the investors within the one or more investor network groups are similarly situated investors with similar investor information (e.g., any information related to the investor profile information, investment strategy information, transaction history information, lifestyle information related to current lifestyles and future desired lifestyle in retirement, investing activity information, or like) inquiries made by investors within the group or suggested investment actions made by financial advisors for investors within the group may apply to multiple investors within the investor network group. Sharing the inquiries and investment suggestions reduces costs for the investors and increases efficiency for the financial institution.

Embodiments of the invention comprise systems, computer program products, and methods for grouping a plurality of investors with similar investor information over a distributed network of investors into a plurality of investor network groups associated with one or more financial advisors for providing responses to investment inquires or suggested investment actions. The present disclosure comprises receiving an inquiry from an investor, wherein the inquiry is received through an investor network interface using an investor computer system. The present disclosure further comprises determining the one or more investor network groups to which the investor belongs, wherein the one or more investor network groups each comprises a plurality of investors. The present disclosure further comprises notifying one or more financial advisors associated with the one or more investor network groups to which the investor belongs of the inquiry. The present disclosure further comprises receiving an inquiry response to the inquiry from the one or more financial advisors associated with the one or more investor network groups. The disclosure further comprises analyzing the inquiry, the inquiry response, and the investor information for the plurality of investors within the one or more investor network groups. The disclosure also comprises determining one or more other investors from the plurality of investors within each of the one or more investor network groups that would be interested in the inquiry and inquiry response, wherein the determination is made based on the analysis of the investor information for the plurality of investors within the one or more investor networks. The present disclosure further comprises presenting the inquiry and the inquiry response to the one or more other investors within each of the one or more investor network groups that were determined to be interested in the inquiry and inquiry response, wherein the inquiry and the inquiry response are presented to the one or more other investors through the investor network interface through investor computer systems.

In further accord with an embodiment of the invention the present disclosure comprises identifying investor information for the investor by accessing investment account information over a network of financial institution systems or third-party systems. The present disclosure further comprises associating the investor with the plurality of investors in each of the one or more investor network groups based on the investor information for the investor and the plurality of investors in the one or more investor network groups, wherein the plurality of investor network groups are stored for access through the investor network interface. The present disclosure further comprises associating the one or more financial advisors with the one or more investor network groups.

In another embodiment, the plurality of investors within each of the one or more investor network groups are grouped based on confidence scores determined from the investor information indicating how alike the plurality of investors are with each other.

In other embodiments, presenting the inquiry and the inquiry response to the one or more other investors within each of the one or more investor network groups further comprises presenting a confidence score along with the inquiry indicating how alike the investor is to each of the one or more other investors.

In still another embodiment, the present disclosure further comprises dynamically assigning the investor to the one or more investor network groups based on changes to the investor information in real-time or near real-time.

In yet another embodiment, notifying one or more financial advisors associated with the one or more investor network groups to which the investor belongs of the inquiry comprises presenting the inquiry to the plurality of investors within the one or more investor network groups. The present disclosure further comprises receiving a notification of interest from the plurality of investors. The present disclosure also comprises determining if the notification of interest meets a threshold level of interest. The present disclosure further comprises notifying the one or more financial advisors of the inquiry when the notification of interest meets the threshold level of interest.

In another embodiment, determining the one or more other investors from the plurality of investors within each of the one or more investor network groups that would be interested in the inquiry and inquiry response, comprises determining one or more categories of interest selected by the plurality of investors and comparing the one or more categories of interest with the inquiry and inquiry response.

In further accord with an embodiment, the present disclosure receives a request from the investor or the one or more other investors to initiate a session with the one or more of financial advisors. The present disclose further comprises presenting a plurality of inquiries to the investor and the one or more other investors. The present disclosure furhter comprises receiving a selection of pre-inquiries to discuss in the session, wherein the pre-inquiries are based on notifications of interest received from the investor or the one or more other investors. The present disclosure comprises notifying the one or more financial advisors of the request for the session and the pre-inquiries for the session.

The present disclosure further comprises determining an investment action taken by a percentage of the plurality of investors within each of the one or more investor network groups, and notifying the investor that the percentage of the plurality of investors within each of the one or more investor network groups are taking the investment action and recommending that the investor take the investment action.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will be made to the accompanying drawings, where:

FIG. 1 presents a block diagram of the investor network system environment, in accordance with embodiments of the present invention;

FIG. 2 illustrates a process flow for an investor network inquiry process, in accordance with embodiments of the present invention;

FIG. 3 illustrates a process flow for an investor suggestion process, in accordance with embodiments of the present invention; and

FIG. 4 illustrates an investor user interface, in accordance with embodiments of the present invention.

### DETAILED DESCRIPTION OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, a “user(s)” described herein may be an investor (e.g., an account holder or a person who has an account, such as an investment account, is looking to open an investment account, or generally has any type of account with the financial institution for a good or service (e.g., product)). In one aspect, a user 4 may be any financial institution customer involved in investment planning with the financial institution or any other affiliates associated with the financial institution. In some embodiments, the user 4 may be an individual who may be interested in opening an investment account with the financial institution. In some other embodiments, a user 4 may be any individual who may be interested in receiving financial information from a financial advisor 8 through the financial institution. For purposes of this invention, the term “user” and “investor” may be used interchangeably.

In some embodiments, a “financial advisor” may be a financial institution employee, contractor, associate, expert, specialist, representative, or the like that provides financial advice to the user 4.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity.

An “account” may be the relationship that the user has with the entity. Examples of accounts include a deposit account, such as a transactional account (e.g. a banking account), a savings account, an investment account, a money market account, a time deposit, a demand deposit, a pre-paid account, a credit account, a non-monetary user profile that includes only personal information associated with the user, or the like. The account is associated with and/or maintained by an entity. In other embodiments, an “entity” may not be a financial institution.

As used herein, a “user interface” may be a graphical user interface. Typically, a graphical user interface (GUI) is a type of interface that allows users 4 to interact with electronic devices such as graphical icons and visual indicators such as secondary notation, as opposed to using only text via the command line. In some embodiments, the graphical user interface may include both graphical elements and text elements.

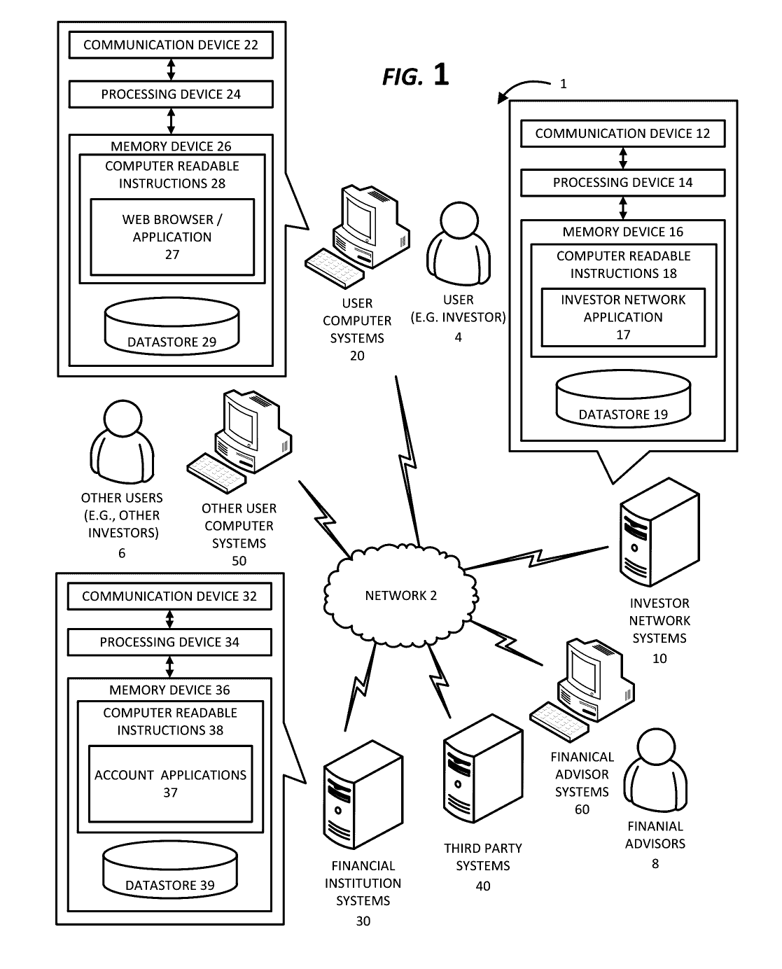

FIG. 1 illustrates an investor network system environment 1, in accordance with an embodiment of the present invention. As illustrated in FIG. 1, one or more investor network systems 10 are operatively coupled, via a network 2, to one or more user computer systems 20 (e.g., investor computer systems 20), one or more financial institution systems 30, one or more third-party systems 40, one or more other investor systems 50, one or more financial advisor systems 60, and/or other like systems. In this way a user 4 (e.g., a primary investor) may utilize the user computer systems 20 to access the investor network application 17 on the investor network systems 10 to network with other users 6 (e.g., other investors) and financial advisors 8 through the other user computer systems 50 (e.g., other investor computer systems 50) and the financial advisor systems 60 to provide and exchange investor information over the investor network system environment 1. In some embodiments of the invention the investor network systems 10 and/or the one or more financial institution systems 30 may store account applications, investment applications, user profile information, and investment account information for the users 4, 6, and thus, the financial institution and the financial advisors 8 within the financial institution may interact with the networked investors 4, 6.

The network 2 may be a global area network (GAN), such as the Internet, a wide area network (WAN), a local area network (LAN), or any other type of network or combination of networks. The network 2 may provide for wireline, wireless, or a combination of wireline and wireless communication between devices on the network 2.

As illustrated in FIG. 1, the investor network systems 10 generally comprise a communication device 12, a processing device 14, and a memory device 16. The processing device 14 is operatively coupled to the communication device 12 and the memory device 16. As used herein, the term “processing device” generally includes circuitry used for implementing the communication and/or logic functions of a particular system. For example, a processing device 14 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 14 may include functionality to operate one or more software programs based on computer-readable instructions 18 thereof, which may be stored in a memory device 16.

The processing device 14 uses the communication device 12 to communicate with the network 2 and other devices on the network 2, such as, but not limited to, the user computer systems 20, the financial institution systems 30, third-party systems 40, other user computer systems 50, financial advisor systems 60, and/or other like systems. As such, the communication device 12 generally comprises a modem, server, or other device for communicating with other devices on the network 2.

As further illustrated in FIG. 1, the investor network systems 10 comprise computer-readable instructions 18 stored in the memory device 16, which in one embodiment includes the computer-readable instructions 18 of an investor network application 17. In some embodiments, the memory device 16 includes a datastore 19 for storing data related to the financial institution systems 10, including, but not limited to, data created and/or used by the investor network application 17.

The investor network application 17 may be a tool, website, mobile device app, or the like that is used to allow groups of networked investors 4, 6 to be grouped together, to communicate with each other and the financial advisor 8, to send and receive information between each other and the financial advisors 8, to pool resources for making decisions and identifying how other investors 4, 6 are reacting, and/or for other tasks described herein.

As illustrated in FIG. 1, a user 4 may access the investor network application 17 through a user computer system 20. The user computer system 20 may be a desktop, laptop, tablet, mobile device (e.g., smartphone device), or any other type of computer that generally comprises a communication device 22, a processing device 24, and a memory device 26.

The processing device 24 is operatively coupled to the communication device 22, and the memory device 26. The processing device 24 uses the communication device 22 to communicate with the network 2 and other devices on the network 2, such as, but not limited to, the investor network systems 10, the financial institution systems 30, the third-party systems 40, the other user systems 50, the financial advisor systems 60, and/or other systems. As such, the communication device 22 generally comprises a modem, server, or other device for communicating with other devices on the network 2 and/or a keypad, keyboard, touch-screen, touchpad, display, microphone, mouse, joystick, other pointer device, button, soft key, and/or other input and/or output device(s) for communicating with the user 4.

As illustrated in FIG. 1, the user computer systems 20 may have computer-readable instructions 28 stored in the memory device 26, which in one embodiment includes the computer-readable instructions 28 of a web browser or another application 27 that allows the user 4 to access the investor network application 17 or receive information from the investor network application 17, or access or receive information from other applications, such as account applications 37, third-party applications, financial advisor applications, or the like. In some embodiments, the memory device 26 includes a datastore 29 for storing data related to the user computer systems 20, including but not limited to data created, received, and/or used by the web browser/application 27. The web browser/application 27 may be an application that allows the user 4 to access websites over a distributed network of systems (e.g., servers), such as the Internet or an intranet. The application 27 may also be a dedicated application for a computer or mobile device that allows the user 4 to access information over the distributed network of systems (e.g., servers), such as the Internet or an intranet.

As illustrated in FIG. 1, the financial institution systems 30 generally comprise a communication device 32, a processing device 34, and a memory device 36. The processing device 34 is operatively coupled to the communication device 32 and the memory device 36. The processing device 34 uses the communication device 32 to communicate with the network 2 and other devices on the network 2, such as, but not limited to, the investor network systems 10, the user computer systems 20, third-party systems 40, other user computer systems 50, financial advisor systems 60, and/or other systems. As such, the communication device 32 generally comprises a modem, server, or other device for communicating with other devices on the network 2.

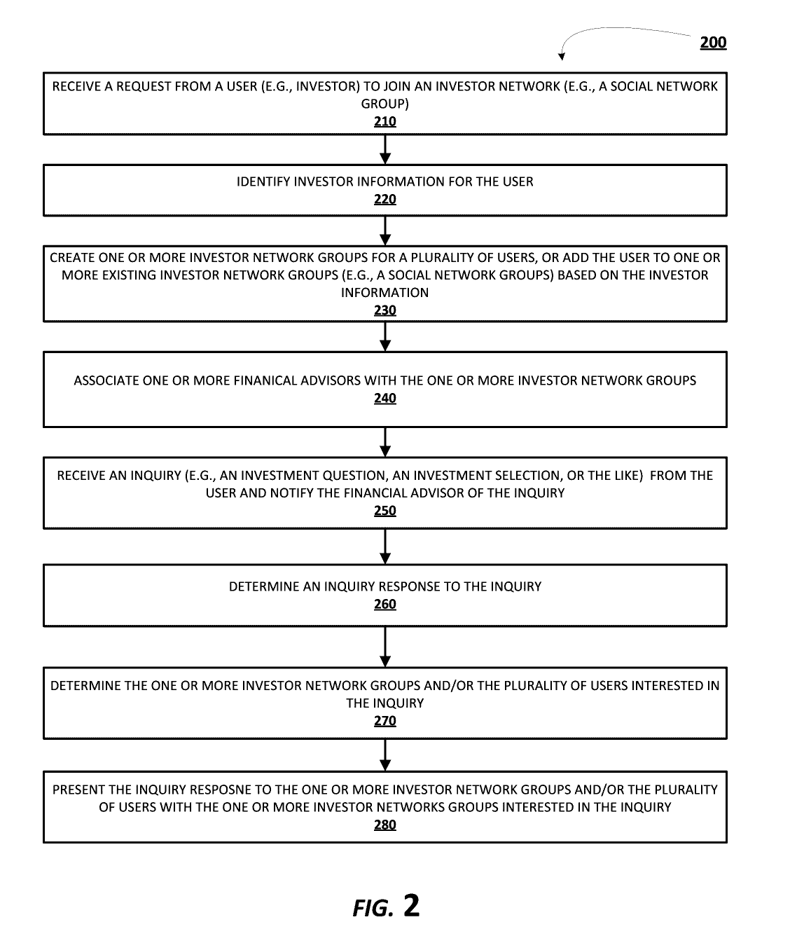

As further illustrated in FIG. 2, the financial institution systems 30 comprise computer-readable instructions 38 stored in the memory device 36, which in one embodiment includes the computer-readable instructions 38 of account applications 37. In some embodiments, the memory device 36 includes a datastore 39 for storing data related to the account systems 30, including but not limited to data created and/or used by the account applications 37.

The account applications 37 may include information about the user's income, accounts, net worth, investments, personal user profile information (e.g., age, dependents, or the like), investment strategies, asset allocation, or other like information. In some embodiments, the financial institution may access this information for the user 4, or the user 4 may access this information directly, in order to provide information to the investor network application 17.

The third-party systems 40, the other user computer systems 50, the financial advisor systems 60, and/or other systems (not illustrated) are operatively coupled to the investor network systems 10, user computer systems 20, and financial institution systems 30, through the network 2. The third-party systems 40, the other user computer systems 50, the financial advisor systems 60, and/or other systems have devices the same as or similar to the devices described for the investor network systems 10, the user computer systems 20, and the financial account systems 30 (e.g., communication device, processing device, memory device with computer-readable instructions, datastore, or the like). Thus, the third-party systems 40, the other user computer systems 50, the financial advisor systems 60, and/or other systems communicate with the investor network systems 10, the user computer systems 20, and the financial institution systems 30, and/or each other in the same or similar way as previously described with respect to the investor network systems 10, the user computer systems 20, and the financial institution systems 30. The third-party systems 40, the other user computer systems 50, the financial advisor systems 60, and/or other systems, in some embodiments, provide additional information about the users 4 or the other users 6, such as but not limited to users' profile information, the users' assets and liabilities, users' investments, or the like that stored by the financial institutions or other financial institutions, which may be used for the investor network application 17, or the like.

In some embodiments of the invention, one or more of the systems may be combined with each other, or otherwise perform the functions of the other systems described herein. In other embodiments of the invention one or more of the applications described herein may be combined with each other, or otherwise perform the functions of the other applications described herein. Furthermore, the applications may be any type of application, such as an application stored on a desktop, server, or other device, a mobile application stored on a mobile device, a cloud application, or other like application. As such, the applications described herein, or portions of the applications described herein may be stored and operated on any of the systems described herein. For example, a portion of the investor network application 17 may be stored on the user computer systems 20, other user computer systems 50, or financial advisor systems 60, in order to achieve the invention described herein (e.g., an investor network app stored on a mobile device of the users 4, 6).

FIG. 2 illustrates a process flow for an investor network inquiry process 200. As illustrated in block 210 of FIG. 2, the investor network system 10 receives a request from an investor 4 (e.g, a first investor) to access an investor network application 17 in order to join one or more investor network groups. In some embodiments of the invention, the investor network group may be a social network or other like group of investors through which investors 4, 6 may communicate with each other and/or one or more financial advisors 8 in order to send and receive information related to investments, or information related thereto, without having the associated expense of a specific one-on-one financial advisor 8. Some investors 4, 6 may not have the assets, are just starting to research investing, do not what to pay the fees associated with having a personal financial advisor 8, and/or have other reasons why the investor 4, 6 cannot hire a personal financial advisor 8. As such, the present invention allows the investor 4 to receive personalized investing information for low cost, while at the same time making it cost effective for the financial institution to provide such financial advice because the advice is provided for a group of investors that have common investing interests, backgrounds, strategies, demographics, or the like. The request to join one or more investor network groups may be received from the investor 4 through the investor computer systems 20.

As illustrated by block 220 in FIG. 2, the identity of the investor 4 may be determined and investor information for the investor 4 may be identified. The investor information may be any information related to the investor profile information (e.g., age, gender, location, net worth, family situation, dependents, interests, hobbies, or the like), investment strategy information (e.g., asset allocation, exposure aversion, trading proficiency, holding duration, investment categories, or the like), transaction history information (e.g., spending habits, fund inflows, fund outflows, goods and services (i.e., products) used, seasonal spending, daily spending, or the like), lifestyle information related to current lifestyles and future desired lifestyle in retirement (e.g., how the investor currently lives and how the investor would like to live in the future), investing activity information (e.g., any financial information requested like publications and financial reports subscribed to or requested, conferences attended, videos demos viewed, selected interests, or the like). This information may be captured from the financial institution systems 30, third party systems 40 (e.g., accounts at other institutions to which the investor 4 has allowed the financial institution to access, or other third-party systems to which the investor has allowed access), or other systems.

Block 230 of FIG. 2 illustrates that one or more investor network groups may be created for a plurality of investors (e.g., the investor 4 and other investors 6, such as a second, third, fourth, or the like investors), or the investor 4 may be added to currently existing one or more investor network groups. As such, the investor 4 may be included in a single investor network group, or otherwise may be included in two or more investor network groups depending on the investor information for the investor 4 when compared to other investors 6. For example, because the investor 4 may have exposure aversion, the investor 4 may be placed in an investor network group with other investors 6 that also have exposure aversion with respect to investments. However, the investor 4 may also be accustom to a particular lifestyle in which the investor 6 spends a lot of money, and as such, may be placed in another investor network group with other investors 6 that have the same type of lifestyle and spending habits. In other embodiments, the investor 4 could be placed in a single investor network group in which the investor 4 and other investors 6 both have exposure aversion and live a lifestyle of spending a lot of money. In other embodiments, the investor 4 may work in a particular industry and/or invest in a particular industry, and as such, may be placed in an investor network group in with other investors 6 that work in the same industry or invest in the same technology. It should be understood, that the investor 4 may be place in any type of investor network group based on the investor information described with respect to block 220, or other information not specifically described. In still other embodiments of the invention, the investor 4 may request to be placed in a specific investor network group in which the investor 4 is interested, which the financial institution may do with or without the investor 4 having investor information that would indicate that the investor 4 may belong in the requested investor network group.

In some embodiments of the invention the investor 4 may be dynamically placed in multiple investor network groups which may change in real-time or near-real time such that the investor 4 may be moving between different investor network groups with or without the knowledge of the investor 6. For example, the investor network interfaces may or may not contain identifying information. As such, the investor network interface may be the same for each of the investors 4, 6; however, as explained in further detail later the investors 4, 6, may only be able to send and receive information through the investor network interface with other investors 4, 6, and one or more financial advisors 8 that are in the investor's investor network group. As such, as the investor information changes for the investor 4 (e.g., as the investor's net assets change, investment strategy changes, asset allocation changes, or the like), investors 6 with whom the investor 4 may share information also changes. In other embodiments of the invention, the various investor network groups may have dedicated investor network interfaces that are specific to the investor network groups, and as such, the investor network groups that the investor 4 may access may change as the investor information changes.

As illustrated by block 240 in FIG. 2, the systems of the present invention associates one or more financial advisors with the one or more investor network groups. In the embodiment in which the investor network group is newly formed the one or more financial advisors 8 may be automatically randomly assigned to the investor network group, or in other embodiments the skills or expertise of the one or more financial advisors 8 may be determined (e.g., from a financial advisor profile, or the like) in order to associate the expertise of the one or more of the financial advisors 8 with the investor information of the investor 4 and the other investors 6 in the investor network group, in order to provide the best services possible to the inventors 4, 6. In the case of a pre-existing investor network group the one or more financial advisors 8 may already be associated with the one or more pre-existing investor network groups, to which additional financial advisors 8 may be added or removed. In still other embodiments of the invention the investors 4, 6 may indicate favorite financial advisors 8, and as such, the financial advisors 8 that have the best score from a particular investor network group may be assigned to the investor network group. In other embodiments of the invention, if the one or more financial advisors 8 receive low score for a particular investor network group the one or more financial advisors 8 may be reassigned to other investor network groups.

Once added to the one or more investor network groups the investor 4 and/or the other investors 6 may be able to access the investor network application 17, including the investor network interface 400, which allows the investor 4 to communicate with the other investors 6 and/or the financial advisors 8 associated within the in the one or more investor network groups, which will be explained in further detail later.

As illustrated by block 250 in FIG. 2, the present invention may receive an inquiry. The inquiry may include a question, statement, request for information, post, product selection (e.g., investment account selection) or any other type of information that an investor 4, 6 may request within the investor network interface 400, or through another interface. The inquiry may be directed to one or more of the investors 6 or the one or more financial advisors 8 within the investor network interface 400 or made public to all of the investors 6 and advisors 8 within the investor network group. For example as illustrated in the example investor network interface 400, the user may pose a question within an investor inquiry section 430, that is specifically directed to another investor 6, or to a specific financial advisor 8.

In other embodiments of the invention, the inquiry itself may be utilized to place the investor 4, 6 in one or more investor network groups. For example, the investor 4 may request to get additional information related to particular financial investments, demonstrations on how to use a particular tool, or the like. As such, in response the system of the present invention may automatically determine, based on the inquiry and/or the investor information, to which investor network groups the investor should belong using a dynamic assignment process. For example, the systems of the present invention may determine other investors 6 that may have made similar inquiries in the past or have similar investment information, and either place the investor 4 in similar investment network group, or display the inquiry to all of the investors 6 that have had made similar inquiries in the past, have similar investment information, or that meet another criteria related to the inquiry of the investor 4. In one embodiment, the investor 4 making the inquiry may be able to see other inquiries from other investors 6 in the past that have made a similar inquiry.

In still other embodiments of the invention, the investors 4 may be able to select categories of interest related to specific investor information. For example, the categories may include categories of investor information that are utilized in order to determine what the investor is interested in. As such, when determining to which investors 6 to present the inquiry, or which investors 6 will be able to see the inquiry (and as such the subsequent responses), the categories selected by the investor 6 may be utilized. For example, if the investors 4 selects that he/she is interested in treasury bonds and technology stocks, then even if the investor information for the investor 4 would not have identified that that the investor 4 would have been interested in these investment vehicles, the selection of the categories may indicate that the investor 4 would like to receive information related to information associated with these selected categories. As such, the investors 4 may receive this type of information in the investor network interface 400.

In other embodiments, the investor 4, 6 may be able to select categories of one or more types of financial advisor 8, or add favorite specific financial advisors 8 (as previously discussed) from which the investor 4 is interested in viewing or receiving information. As such, the investors 4 may receive inquiries, responses, comments, suggested actions, or the like from the selected category of financial advisors 8 and/or the specific financial advisor 8 selected by the investor 4. Moreover, the investor 4 may be able to select favorite specific investors 6 for which the investor 4 would like to receive and/or view any inquiries, responses, comments, or the like regardless of the topic.

Furthermore, the investors 4, 6, may make different selections in order to determine the types of inquiries that the one or more investors 4, 6 may receive. For example, under the category selection section the investor 4, 6, may indicate that the investor 4, 6 would like to view all inquiries related to particular investment areas, but only receive other inquiries from investors that that meet specific criteria attributes. For example, the investor 4 may select two (2) criteria attributes (e.g., investors that are between the ages of 50 and 59 years old, and have net assets over $500,000), and thus receive or be able to view in the investor inquiry section 430 hundreds or thousands of inquiries that meet the two selected criteria attributes. The more criteria attributes selected by the investor 4, the more filtered the results may be. For example, the selection of ten (10) criteria may result in only receiving or being able to view tens of inquiries.

In some embodiments of the invention after an inquiry is made within the investor network interface 400, the financial advisor 8 may be the only person that can respond (e.g., answer the question, provide links, provide suggestions, or the like) to the inquiry and/or comment on the inquiry. In still other embodiments of the invention, the other investors 6 within the investor network group are also able to respond the inquiry; however, in some embodiments the other investors 6 are only able to comment on the inquiry made by the investor 4 (e.g., first investor) and/or the answer provided by the one or more financial advisors 8 after the one or more financial advisors 8 have provided a response to the inquiry. As such, in some embodiments any investor 4, 6 or financial advisor 8 may respond to the inquiry at any time, while in other embodiments, only some of the investors 4, 6 and/or financial advisors 8 may respond to an inquiry or comment with respect to an inquiry.

In some embodiments, after an inquiry is posed within the investor network interface 400 a financial advisor 8 is notified of the inquiry. The inquiry may be sent to any available financial advisor 8, or it may be directed to a specific financial advisor 8. In this way the one or more financial advisors 8 may be able to regulate and determine the inquiries that may be the most beneficial to the investors 4, 6, within the investor network group. As such, the one or more financial advisors 8 may select the inquiries, and the responses for the inquiries, to display in the investor network interface 400 for viewing by the investors 4, 6.

In other embodiments of the invention the inquiries may be posted for all investors 4, 6 to view. As illustrated in the investor inquiry section 430 of the investor network interface 400, the investors 4, 6 within the investor network group may provide a notification of interest in the inquiries by selecting the inquiries that the investors 4, 6 want the financial advisors 8 to answer by scoring, liking, disliking, voting for, rating, or the like the particular inquiries as illustrated by the inquiry selection section 440. In some embodiments, the financial advisors 8 will only be able to respond to the inquiry after the inquiry meets a selection threshold level of interest (e.g., percent score, total score, number of votes, total different between likes and dislikes, meets a specific rating, or the like). In other embodiments, the financial advisors 8 may use the selection feature as a tool to determine the inquiries to which the one or more investors 4, 6 wants a response, but may respond or not respond to an inquiry as desired.

As illustrated by block 260 of FIG. 2, some of the determined responses to the inquiries presented may be made manually by the other investors 6 and/or the one or more financial advisors 8. In other embodiments, the determined response may be made automatically by analyzing the inquiry request, and presenting information as a response to the inquiry. For example, if the investor 4 uses a particular keyword or phrase an automatic response may be displayed in the inquiry section 430 with or without the one or more financial advisors 8 revising and/or supplementing the response. In other examples the investor inquiry may be a request for information (e.g., investor selects a button requesting additional information regarding a particular investment), and as such canned information or canned information supplemented with information base on the investor information related specifically to the requesting investor 4 may be automatically determined as a response to the investor inquiry. For example, based on the investor's inquiry and/or the investment information, the system may automatically present the investment information that is tailored to the investor 4 based on the investor's investment profile (e.g., low exposure profile may receive low exposure investment information, while high exposure profile may receive high profile investment information).

Block 270 of FIG. 2 illustrates that the system determines the one or more investor network groups and/or the other investors 6 within the investor network groups to which to display the inquiry and/or response. For example, the investor 4 may have made the inquiry within a particular investor network interface for a particular investor network group. As such, the response to the inquiry may at least be displayed within the investor network group through with the inquiry was made. In some embodiments, depending on the type of investor network group, the investors 6 within the group may be investors 6 that are all close to retirement age, and some of which may allocate no investment funds towards technology stocks and other investors within the investor network group that may allocate more than 30% of investments towards technology stocks. In some embodiments if the inquiry relates to particular technology stock, the inquiry may only be presented to investors that allocate at least some, or more than 30%, of investments funds in technology stocks. Continuing with this example in some embodiments, the investor 4 that made the inquiry may belong to three different types of investor network groups, such as an investor network group of liked aged investors with similar net assets some of which invest at least 30% of assets in technology stocks, an investor network group that is made up of people employed by technology companies, and an investor network group that owns rental property. As previously discussed the investor 4 may have made an inquiry regarding technology stocks, as such the technology stock inquiry and response may be presented to the investors 6 in the investor network group with similar net assets and ages to the investor 4, and which invest more than 30% of assets in technology stocks, and to all of the investors in the investor network group of people employed by technology companies, but not to the investors 6 in the investor network group that own rental property.

As illustrated by block 280 in FIG. 2 the systems of the present invention present the inquiry 434, response 436, and/or comments 438 from investors 6 within the one or more investor network groups and/or to specific investors 6 within the one or more investor network groups, through an investor network interface 400, which is described in further detail later. As previously discussed, the investor networks groups allow like investors to be paired together in order to share investor information and received investment advice from a financial advisor 8 in a group setting in order to reduce the costs associated with paying a financial advisor 8.

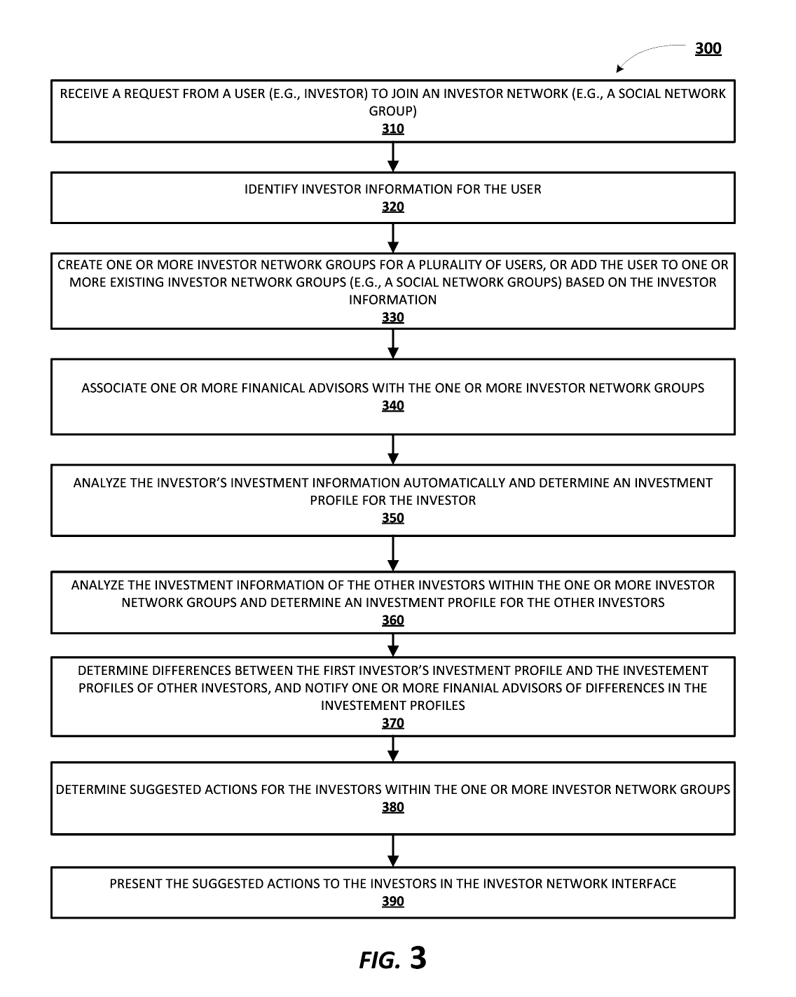

In some embodiments of the invention, along with presenting the inquiry and the responses to the investor 4, the systems of the present invention may present a confidence score associated with each of the other investors 6 that responds to the first investor's inquiry. The confidence score may be based on the assets, liabilities, investment strategies, exposure aversion, investment goals, rates of return, allocations, retirement benefits, retirement age, lifestyle, or any other like investment information that may be utilized to compare investors 4, 6 to each other. The investment profile may be scored in order to provide a confidence level to illustrate how alike (or unlike) the investor 4 is to other investors within or outside of the investor's investor network groups, as explained in further detail with respect to FIG. 3. For example, when illustrating an inquiry in the investor inquiry and response section 430 of the investor network interface 400, a confidence score may be included in the investor information section 432 illustrating how alike (or unlike) the second investor 6 is to the first investor 4. This confidence score may provide additional insight to the investor 4 in making a determination of how much weight to lend to the inquiries, responses, and/or comments submitted by the other investors 6. As such, a first investor 4 may lend more weight to a second investor 6 response and/or comment if the second investor 6 has a high confidence as being like the first investor 4.

FIG. 3 illustrates another embodiment of invention in which the systems of the present invention provide suggestions to an investor 4 based on what other investors 6 in the investor network groups are doing. As illustrated by blocks 310 to 340 the systems of the present invention receive a request from the investor 4, identify investor information for the investor 4, create one or more investor network groups for the investors 4, 6 or places the investor 6 in one or more current investor network groups, and associate one or more financial advisors 8 with the one or more investor network groups as previously discussed with respect to blocks 210 to 240 in FIG. 2.

As illustrated by block 350 in FIG. 3, the system of the present invention automatically analyzes the investor's investment information, for example the investor's long term investment decisions, short term investment decisions, and other like investment information described throughout this specification. In some embodiments, the systems of the present invention may use this investment information as a comparison with other investors to determine suggested actions for the investor 4. In some embodiments, the systems may use the investment information to create a standardized investment profile for the investor 4, which creates a format that may used to easily compare the investor 4, with other investors 6. The investment profile may include the investors 4, 6 assets, liabilities, investment strategies, exposure aversion, investment goals, rates of return, allocations, retirement benefits, retirement age, lifestyle, or any other like investment information that may be utilized to compare investors 4, 6 to each other. The investment profile may be scored, for example, with a confidence score as previously discussed, in order to provide a confidence level to illustrate how alike (or unlike) the investor 4 is to other investors within or outside of the investor's investor network groups, as explained in further detail below.

Block 360 of FIG. 3 illustrates that the system also analyzes the investment information for the other investors 6, for example the long term investment decisions, and short term investment decisions of the other investors 6. As such, the system may utilize this analysis to determine suggested investment actions for the investors 4, 6. In some embodiments, the system uses the analysis of the investment information to determine an investment profile for the one or more other investors 6. As previously discussed the investment profiles may be scored to provide a confidence level to illustrate how alike (or unlike) the investors 4, 6 are to each other within or outside of the investor network groups, as explained in further detail below.

Block 370 of FIG. 3 illustrates that a determination is made when the first investor's investment profile (e.g., using the scores of the investment profile and/or the investment information used to create the confidence scores) has differences with the investment profiles of the other investors 6 within the first investor's investment network groups to which the first investor 4 belongs. For example, the first investor 4 may be nearing retirement age, and be associated with other investors 6 of similar retirement age within an investor network group. The system may determine from the investment profiles within this investor network group that the first investor 4 has a high exposure to a down market, in which the investor 4 could lose a significant amount of assets if the market hits a downturn, while 90% of the other investors 6 within the first investor's investment group have low exposure indicating that they are better situated to weather a market downturn. As such, in some embodiments, based on the differences (or similarities) between the investors 4, 6, the one or more financial advisors 8 may be notified to review the investment profile of the first investor 4. In some embodiments of the invention, the one or more financial advisors 8 may not be notified of the analysis that results in the investment profiles of the investors 4, 6, and may simply review the investment profiles as necessary.

As illustrated by block 380 in FIG. 3 determinations may be made for suggested actions that the first investor 4 may want to take. The one or more financial advisors 8 may review the notifications and the investment profiles of the investors 4, 6 discussed in blocks 350 to 370, and determine suggested actions for the first investor 4. In other embodiments of the invention, the suggested actions for the first investor 4 may be determined automatically by the systems of the present invention. For example, if the financial institution has a standard investment profile for the investors 4, 6 of a particular age, net worth, exposure (e.g., high, medium, low exposure) in general, or for specific investor network groups, the system may automatically suggest to the investors 4, 6 to adjust the investment profile when the investors 4, 6 do not fall within the standard investment profile. For example, continuing with the example discussed with respect to block 370, for investors 4, 6 that are about to retire the financial institution may typically suggest to an investor 4 to have a low exposure profile and only 20% of assets in stocks, 20% in cash equivalents, and 60% in bonds and other safer annuity assets. As such, the systems of the present invention may suggest particular changes to the investor's profile, such as a suggestion to change the high exposure profile of the first investor 4 to the low exposure profile that 90% of the investors 6 in the investor's investor network group utilize.

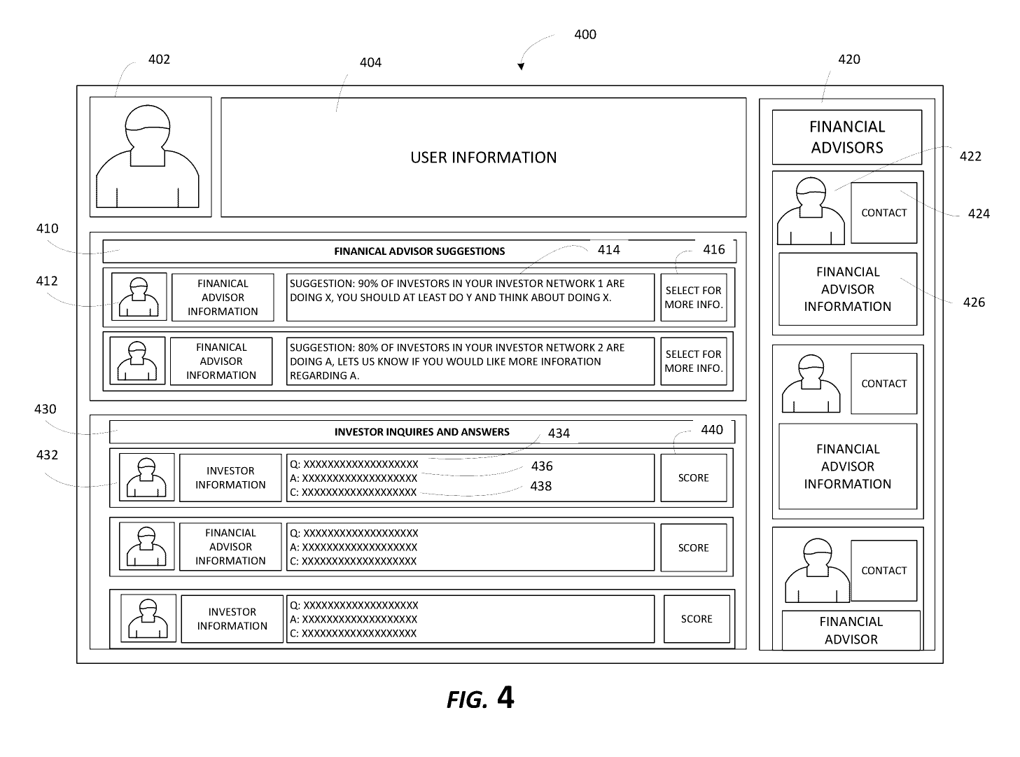

As illustrated by block 390 of FIG. 3, the system may present to the first investor 4 the suggested action in a suggested action section 414 of the investor network interface 400. For example, as illustrated in the financial advisor suggestion section 410 of the investor network interface 400 illustrated in FIG. 4, the system and/or the one or more financial advisors 8 may suggest that because 90% of investors in the investor's investor network group are taking a particular action, then the investor 4 should also take the suggested action. The suggested actions may be related to anything based on the investment information for the investors 6 with which the first investor 4 has been grouped, as previously discussed. As illustrated by the select additional information section 416, if the investor 4 wants additional information related to the suggested action, the investor may request additional information.

Alternatively, or in addition to providing suggested actions directly to the first investor 4, or the other investors 6, within the one or more investor network groups, the system and/or the one or more financial advisors 8 may present group suggestions that are distributed to the financial advisor suggestion section 410 for each individual investor 4, 6, or to the investor inquiry section 430, as a general suggestion to all investors 4, 6 that have access to the investor network interface 400. As such, the investors 4, 6 may receive specialized suggested actions or specific suggested actions within the financial advisor suggestion section 410, or in other embodiment in the investor inquiry and response section 430. In this way the one or more advisors 8 may present unsolicited recommendations or information to the investors 4, 6, within specific groups or across various groups.

Moreover, when presented with a suggested action (or inquires, responses to the inquires, or the like) in one or more of the interfaces the investors 4, 6 may at the time the suggested action (or inquires, responses to the inquires, or the like) is presented, or at a later point in time, provide an indication of agreement or disagreement (by scoring, liking, disliking, voting for, rating, or the like the) with the suggested action (or inquires, responses to the inquires, or the like). The indication of agreement may be an indication that the investors 4, 6 actually took the action or it may be an indication that the investors 4, 6 didn't take the action but generally agree with it. For example, the investors 4, 6 may have taken the suggested action and at a later point in time may want to indicate if the investors 4, 6 received a favorable results based on taking the suggested action.

In some embodiments of the invention, the results of the investors 4, 6 taking the suggested actions may also be provided. This may include the system identifying the inventors 4, 6 that took action after the suggested actions were provided in the interfaces. The results of such actions may be presented along with the number of investors 4, 6 that took the suggested action. For example, in some embodiments the financial advisors 8 may suggest a particular investment action (e.g., stock purchase, exposure reallocations, or the like). In response ten out (10) out of twenty (20) inventors 4, 6, may have taken the suggested action. The system may present in the interfaces that ten of the twenty investors within the investor network took the suggested action and in response the ten investors received a ten (10) percent return (e.g., on average, or for specific investors), while the ten investors that did not take the action received only a five (5) percent return (e.g., on average, or for specific investors).

In some embodiments, as previously discussed, not only is a confidence score presented related to how alike (or unlike) the investors 4, 6 are to each other, but the actual similarities and differences are presented to the investors 4, 6. For example, the interface may illustrate that the investors 4, 6 have the same investment strategies, as being the reason the investors 4, 6, were identified as related. Alternatively, for example, the interfaces may illustrate how the investors 4, 6 are unlike each other, and the interfaces may also illustrate how the inventors 4, 6 could be more alike if the investors 4, 6 were to take particular suggested actions. For example, if a first investor 4 were to reallocate the first investor's investments in a suggested way the first investor 4 would be more closely aligned with the other investors 6. As such, the present disclosure illustrates how the investors within an investor network may be more aligned with each other.

In other embodiments of the invention the inquiries may be posted for all investors 4, 6 to view. As illustrated in the investor inquiry section 430 of the investor network interface 400, the investors 4, 6 within the investor network group may provide a notification of interest in the inquiries by selecting the inquiries that the investors 4, 6 want the financial advisors 8 to answer by scoring, liking, disliking, voting for, rating, or the like the particular inquiries as illustrated by the inquiry selection section 440. In some embodiments, the financial advisors 8 will only be able to respond to the inquiry after the inquiry meets a selection threshold level of interest (e.g., percent score, total score, number of votes, total different between likes and dislikes, meets a specific rating, or the like).

In some embodiments of the invention the investor 4 may be able to make a payment in order to have an individual session with one or more of the financial advisors 8 to discuss investment information. The present invention may also allow two or more investors 4, 6 to make a payment to have a group session with the one or more financial advisors 8 to discuss investment information and reduce the cost for such sessions. For example, a particular number of investors 4, 6 that have similar inquiries or investment profiles within or across investor network groups, or the investor network group as a whole, may participate in an investor session (e.g., teleconference, meeting, chat conversion, video conference, or the like) that allows the investors 4, 6 to received personalized investment strategies that are typically only provided on an individual basis. These sessions are only possible because the investors 4, 6 have been grouped into a similar investor network groups, and as such, the suggested actions provided by the one or financial advisors 8 during a group session will likely apply to the majority of investors 4, 6 within the session.

In some embodiments of the invention, before a financial advisor 8 holds a group session (e.g., teleconference, instant message chat, or the like) with a group of the investors 4, 6, the investors 4, 6 may present pre-inquiries related to the topics that the investors 4, 6 would like to discuss during the session. In some embodiments the pre-inquiries may be selected by the investors 4, 6, as previously disused (e.g., scored, voted on, or the like), which are going to be a part of the session in order to determine the topics that will be presented and discussed by the one or more financial advisors 8 during the session. For example, the list of pre-inquiries may cover a range of topics that one or more of the investors 4, 6 may be interested in hearing about during the session, and pre-selection of the pre-inquiries assures that the topics will be relevant to the investors 4, 6 participating in the sessions.

In other embodiments, the investors 4, 6, may want to have an individual session with the financial advisors 8. As such, in some embodiments the financial advisors 8 for the investor network group may be illustrated in a financial advisors section 420 of the investor network interface 400. The financial advisors section 420 may comprise a photo of the financial advisor 422, contact information for the financial advisor 424, and financial advisor information 426 related to the financial advisor's specialties, expertise, ratings, or the like. As such, the investors 4, 6, may use the information in the financial advisors section 420 to select a financial advisor 8 from the investor network group to set up an individual or group session.

In other embodiments of the invention, in order to view the responses provided by the one or more advisors 8 to the inquiries of the investors 4, 6 in the investor inquiry section 430, the investors 4, 6 may have to provide a nominal payment to view the answers (e.g., cents, or the like). This may spread the cost associated with the one or more financial advisors 8 reviewing the inquiries and providing responses across the multiple investors 4, 6 that receiving the benefit of the response. For example, if the financial advisor is providing recommendations for changing asset allocations based on economic factors, the investors 4, 6 that may receive the benefit of the recommendations should share the cost of the recommendations. As such, some responses to the inquiries may require a payment by the investors 4, 6 in order to view the responses. In other embodiments, the investors 4, 6 may make daily, monthly, yearly, or other like subscription payments to have access to all of the inquiries and responses within the investor network group. These payments may allow the investors 4, 6 to received personalized investment information (e.g., because the investors within the investor network group have related interests) without having to make more expensive payments for individual investment advice from a financial advisor 8.

In accordance with embodiments of the invention, the term “module” may be used herein with respect to a system, and may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, JAVA, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

To supplement the present disclosure, this application further herein incorporates by reference in their entirety the following commonly assigned patent applications:

| Docket Number | U.S. patent application Ser. No. | Title | Filed On |
|---|---|---|---|
| 6508US1.014033.2439 | | GENERATING A ONE-CLICK | Concurrently |
| | | FINANCIAL PLAN | Herewith |
| 6514US1.014033.2441 | | AUTOMATED FUND | Concurrently |
| | | REALLOCATION BASED ON | Herewith |
| | | GOAL PROGRESS | |
| 6515US1.014033.2442 | | AN INTEGRATED FINANCIAL | Concurrently |
| | | AND HEALTH MONITORING | Herewith |
| | | SYSTEM UTILIZING | |
| | | WEARABLE DEVICES | |
| 6517US1.014033.2443 | | MODIFYING AN ESTIMATED | Concurrently |
| | | FINANCIAL PLAN | Herewith |
| 6518US1.014033.2444 | | GOAL GUARANTEE SYSTEM | Concurrently |
| | | | Herewith |

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for grouping a plurality of investors with similar investor information over a distributed network of investors into a plurality of investor network groups associated with one or more financial advisors for providing responses to investment inquires or suggested investment actions, the system comprising:
one or more memory devices; and
one or more processing devices operatively coupled to the one or more memory devices, wherein the one or more processing devices are configured to execute computer-readable program code to:
receive an inquiry from an investor, wherein the inquiry is received through an investor network interface using an investor computer system;
determine the one or more investor network groups to which the investor belongs, wherein the one or more investor network groups each comprises a plurality of investors;
notify one or more financial advisors associated with the one or more investor network groups to which the investor belongs of the inquiry;
receive an inquiry response to the inquiry from the one or more financial advisors associated with the one or more investor network groups;
analyze the inquiry, the inquiry response, and investor information for the plurality of investors within the one or more investor network groups;
determine one or more other investors from the plurality of investors within each of the one or more investor network groups that would be interested in the inquiry and inquiry response, wherein the determination is made based on the analysis of the investor information for the plurality of investors within the one or more investor networks; and
present the inquiry and the inquiry response to the one or more other investors within each of the one or more investor network groups that were determined to be interested in the inquiry and inquiry response, wherein the inquiry and the inquiry response are presented to the one or more other investors through the investor network interface through investor computer systems.

2. The system of claim 1, wherein the one or more processing devices are further configured to execute computer-readable program code to:
identify investor information for the investor by accessing investment account information over a network of financial institution systems or third-party systems;
associate the investor with the plurality of investors in each of the one or more investor network groups based on the investor information for the investor and the plurality of investors in the one or more investor network groups, wherein the plurality of investor network groups are stored for access through the investor network interface; and
associate the one or more financial advisors with the one or more investor network groups.

3. The system of claim 2, wherein the plurality of investors within each of the one or more investor network groups are grouped based on confidence scores determined from the investor information indicating how alike the plurality of investors are with each other.

4. The system of claim 1, wherein presenting the inquiry and the inquiry response to the one or more other investors within each of the one or more investor network groups further comprises presenting a confidence score along with the inquiry indicating how alike the investor is to each of the one or more other investors.

5. The system of claim 1, wherein the one or more processing devices are further configured to execute computer-readable program code to:
dynamically assign the investor to the one or more investor network groups based on changes to the investor information in real-time or near real-time

6. The system of claim 1, wherein notifying one or more financial advisors associated with the one or more investor network groups to which the investor belongs of the inquiry comprises:
presenting the inquiry to the plurality of investors within the one or more investor network groups;
receiving a notification of interest from the plurality of investors;
determining if the notification of interest meets a threshold level of interest; and
notifying the one or more financial advisors of the inquiry when the notification of interest meets the threshold level of interest.

7. The system of claim 1, wherein determining the one or more other investors from the plurality of investors within each of the one or more investor network groups that would be interested in the inquiry and inquiry response, comprises determining one or more categories of interest selected by the plurality of investors and comparing the one or more categories of interest with the inquiry and inquiry response.

8. The system of claim 1, wherein the one or more processing devices are further configured to execute computer-readable program code to:
receive a request from the investor or the one or more other investors to initiate a session with the one or more of financial advisors;
present a plurality of inquiries to the investor and the one or more other investors;
receive a selection of pre-inquiries to discuss in the session, wherein the pre-inquiries are based on notifications of interest received from the investor or the one or more other investors; and
notify the one or more financial advisors of the request for the session and the pre-inquiries for the session.

9. The system of claim 1, wherein the one or more processing devices are further configured to execute computer-readable program code to:
determine an investment action taken by a percentage of the plurality of investors within each of the one or more investor network groups; and
notify the investor that the percentage of the plurality of investors within each of the one or more investor network groups are taking the investment action and recommending that the investor take the investment action.

10. A computer program product for grouping a plurality of investors with similar investor information over a distributed network of investors into a plurality of investor network groups associated with one or more financial advisors for providing responses to investment inquires or suggested investment actions, comprising at least one non-transitory computer-readable medium having computer-readable program code portions embodied therein, the computer-readable program code portions comprising:
an executable portion configured to receive an inquiry from an investor, wherein the inquiry is received through an investor network interface using an investor computer system;
an executable portion configured to determine the one or more investor network groups to which the investor belongs, wherein the one or more investor network groups each comprises a plurality of investors;
an executable portion configured to notify one or more financial advisors associated with the one or more investor network groups to which the investor belongs of the inquiry;
an executable portion configured to receive an inquiry response to the inquiry from the one or more financial advisors associated with the one or more investor network groups;
an executable portion configured to analyze the inquiry, the inquiry response, and investor information for the plurality of investors within the one or more investor network groups;
an executable portion configured to determine one or more other investors from the plurality of investors within each of the one or more investor network groups that would be interested in the inquiry and inquiry response, wherein the determination is made based on the analysis of the investor information for the plurality of investors within the one or more investor networks; and
an executable portion configured to present the inquiry and the inquiry response to the one or more other investors within each of the one or more investor network groups that were determined to be interested in the inquiry and inquiry response, wherein the inquiry and the inquiry response are presented to the one or more other investors through the investor network interface through investor computer systems.

11. The computer program product of claim 10, wherein the computer-readable program code portions further comprise:
an executable portion configured to identify investor information for the investor by accessing investment account information over a network of financial institution systems or third-party systems;
an executable portion configured to associate the investor with the plurality of investors in each of the one or more investor network groups based on the investor information for the investor and the plurality of investors in the one or more investor network groups, wherein the plurality of investor network groups are stored for access through the investor network interface; and
an executable portion configured to associate the one or more financial advisors with the one or more investor network groups.

12. The computer program product of claim 10, wherein the plurality of investors within each of the one or more investor network groups are grouped based on confidence scores determined from the investor information indicating how alike the plurality of investors are with each other.

13. The computer program product of claim 10, wherein the executable portion configured to present the inquiry and the inquiry response to the one or more other investors within each of the one or more investor network groups further comprises presenting a confidence score along with the inquiry indicating how alike the investor is to each of the one or more other investors.

14. The computer program product of claim 10, wherein the computer-readable program code portions further comprise an executable portion configured to dynamically assign the investor to the one or more investor network groups based on changes to the investor information in real-time or near real-time.

15. The computer program product of claim 10, wherein the executable portion configured to notify the one or more financial advisors associated with the one or more investor network groups to which the investor belongs of the inquiry further comprises:
presenting the inquiry to the plurality of investors within the one or more investor network groups;
receiving a notification of interest from the plurality of investors;
determining if the notification of interest meets a threshold level of interest; and
notifying the one or more financial advisors of the inquiry when the notification of interest meets the threshold level of interest.

16. The computer program product of claim 10, wherein the executable portion configured to determine the one or more other investors from the plurality of investors within each of the one or more investor network groups that would be interested in the inquiry and inquiry response further comprises determining one or more categories of interest selected by the plurality of investors and comparing the one or more categories of interest with the inquiry and inquiry response.

17. The computer program product of claim 10, wherein the computer-readable program code portions further comprise:
an executable portion configured to receive a request from the investor or the one or more other investors to initiate a session with the one or more of financial advisors;
an executable portion configured to present a plurality of inquiries to the investor and the one or more other investors;
an executable portion configured to receive a selection of pre-inquiries to discuss in the session, wherein the pre-inquiries are based on notifications of interest received from the investor or the one or more other investors; and
an executable portion configured to notify the one or more financial advisors of the request for the session and the pre-inquiries for the session.

18. The computer program product of claim 10, wherein the computer-readable program code portions further comprise:
an executable portion configured to determine an investment action taken by a percentage of the plurality of investors within each of the one or more investor network groups; and
an executable portion configured to notify the investor that the percentage of the plurality of investors within each of the one or more investor network groups are taking the investment action and recommending that the investor take the investment action.

19. A method for grouping a plurality of investors with similar investor information over a distributed network of investors into a plurality of investor network groups associated with one or more financial advisors for providing responses to investment inquires or suggested investment actions, the method comprising:
receiving, by one or more processing devices, an inquiry from an investor, wherein the inquiry is received through an investor network interface using an investor computer system;
determining, by the one or more processing devices, the one or more investor network groups to which the investor belongs, wherein the one or more investor network groups each comprises a plurality of investors;
notifying, by the one or more processing devices, one or more financial advisors associated with the one or more investor network groups to which the investor belongs of the inquiry;
receive, by the one or more processing devices, an inquiry response to the inquiry from the one or more financial advisors associated with the one or more investor network groups;
analyzing, by the one or more processing devices, the inquiry, the inquiry response, and investor information for the plurality of investors within the one or more investor network groups;
determining, by the one or more processing devices, one or more other investors from the plurality of investors within each of the one or more investor network groups that would be interested in the inquiry and inquiry response, wherein the determination is made based on the analysis of the investor information for the plurality of investors within the one or more investor networks; and
presenting, by the one or more processing devices, the inquiry and the inquiry response to the one or more other investors within each of the one or more investor network groups that were determined to be interested in the inquiry and inquiry response, wherein the inquiry and the inquiry response are presented to the one or more other investors through the investor network interface through investor computer systems.

20. The method of claim 19, wherein presenting the inquiry and the inquiry response to the one or more other investors within each of the one or more investor network groups further comprises presenting a confidence score along with the inquiry indicating how alike the investor is to each of the one or more other investors.

21. The method of claim 19, further comprising:
dynamically assigning the investor to the one or more investor network groups based on changes to the investor information in real-time or near real-time

22. The method of claim 19, further comprising:
determining an investment action taken by a percentage of the plurality of investors within each of the one or more investor network groups; and
notifying the investor that the percentage of the plurality of investors within each of the one or more investor network groups are taking the investment action and recommending that the investor take the investment action.
